(19) United States
(12) Patent Application Publication
(10) Pub. No.: US 2025/0308317 A1
(43) Pub. Date: Oct. 2, 2025

(54) ARTICLE SUPPLY DEVICE AND ARTICLE SUPPLY DEVICE SET

(71) Applicant: BANDAI CO., LTD., Tokyo (JP)

(72) Inventors: Hajime KONDO, Tokyo (JP); Tatsushi IKARASHI, Tokyo (JP); Yoshiaki TATSUKI, Tokyo (JP)

(21) Appl. No.: 19/086,325

(22) Filed: Mar. 21, 2025

(30) Foreign Application Priority Data
Mar. 26, 2024 (JP) 2024-049844

(51) Int. Cl. G07F 9/10; A45F 3/08; G07F 11/44

(52) U.S. Cl. CPC G07F 9/10; A45F 3/08; G07F 11/44

(57) ABSTRACT

An article supply device includes: a body portion including a front face portion, a back face portion, and a bottom face portion; an operating portion that is located on the front face portion and enables operation for supplying an article; and a supply port that is located on the front face portion and through which the article in the device can be supplied, in which the body portion can be held with the bottom face portion lifted. For example, the body portion is provided with a holding portion that enables the body portion to be held with the back face portion facing the front, the back, or a side of the torso of a human body.

### CROSS-REFERENCE TO RELATED APPLICATIONS

This application claims priority to Japanese Patent Application No. 2024-049844 filed in the Japan Patent Office on Mar. 26, 2024, the entire contents of which are incorporated herein by reference.

### BACKGROUND OF THE INVENTION

### 1. Field of the Invention

The present invention relates to an article supply device and an article supply device set.

### 2. Description of the Related Art

Various article supply devices (vending machines) for automatically selling products are known these days. An article supply device has various functions for determining the payment necessary to purchase a product. For example, Japanese Unexamined Patent Application Publication No. 2017-59114 discloses the configuration of an article supply device that performs control such that when a genuine coin is inserted, a locking member operates to enable an operation to purchase a product.

Japanese Unexamined Patent Application Publication No. 2017-59114 relates to the control of article purchase in the article supply device. When this type of device is placed at a low position such as the ground surface, the purchaser needs to lower his/her body to purchase a product (an article).

### SUMMARY OF THE INVENTION

An object of the present invention is to provide an article supply device that is more convenient for users than ones in the related art.

An article supply device according to an aspect of the present invention includes: a body portion including a front face portion, a back face portion, and a bottom face portion; an operating portion that is located on the front face portion and enables operation for supplying an article; and a supply port that is located on the front face portion and through which the article in the device can be supplied, and the body portion can be held with the bottom face portion lifted.

With the present invention, it is possible to provide a highly convenient article supply device.

### BRIEF DESCRIPTION OF THE DRAWINGS

FIG. 1 is a perspective view of an article supply device according to an aspect of the present invention, illustrating its outer appearance;

FIG. 2 is a schematic cross-sectional view taken along line II-II in FIG. 1;

FIG. 3 is a side view of the article supply device in a held state;

FIG. 4 is a back view of the article supply device in a held state;

FIG. 5 is a perspective view of the article supply device, illustrating an example of an operable state;

FIG. 6 is a side view showing another example of the way of holding the article supply device on the back; and

FIG. 7 is a perspective view showing another holding state of the article supply device.

### DESCRIPTION OF THE PREFERRED EMBODIMENTS

Hereinafter, an article supply device according to an aspect of the present invention will be described with reference to the figures.

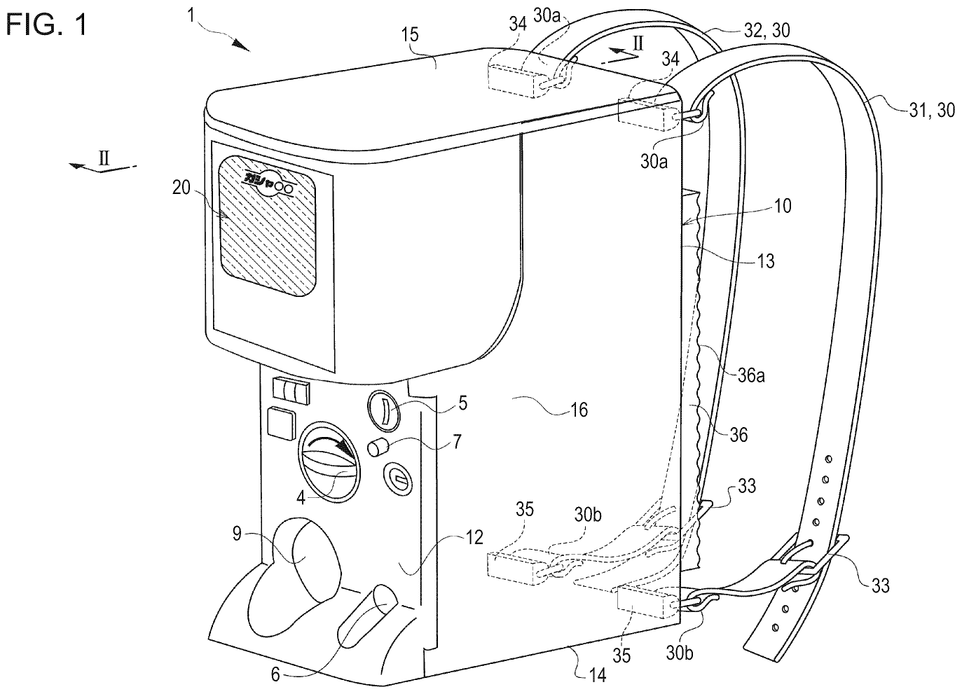

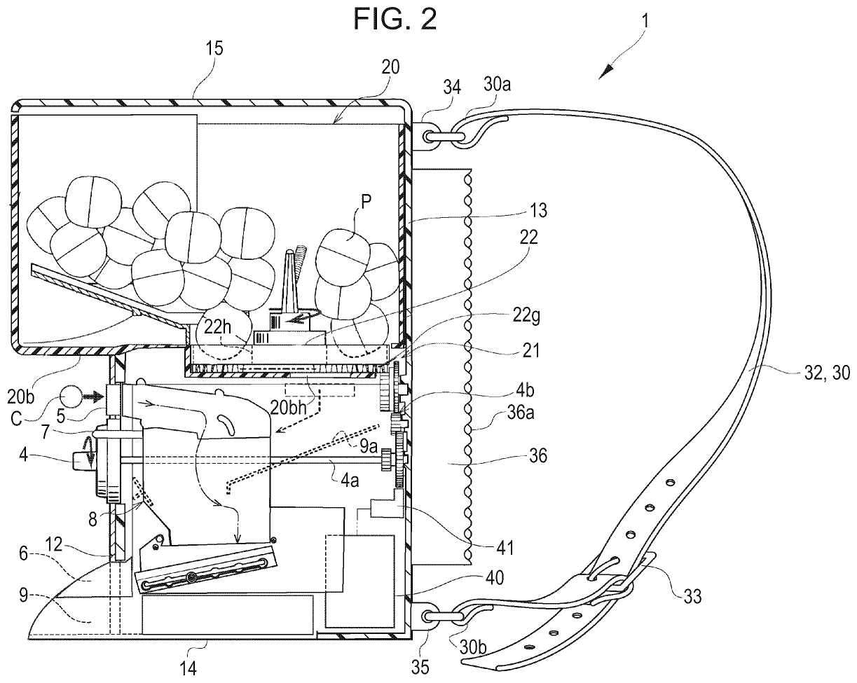

FIG. 1 is a perspective view of an article supply device 1 of the present aspect, illustrating its outer appearance, and FIG. 2 is a schematic cross-sectional view taken along line II-II in FIG. 1.

The article supply device 1 illustrated in FIGS. 1 and 2 has a box shape in which a body portion 10 includes a front face portion 12, a back face portion 13, a bottom face portion 14, and right and left side face portions 16. The article supply device 1 is capable of supplying articles P stored inside, specifically, articles P (products) which are spherical capsule cases containing toys, small parts, and the like. The article supply device 1 includes an article storage 20 capable of storing a plurality of articles P in a random arrangement, a supply portion 21 including a rotation plate 22 that is rotatably provided at a bottom portion 20b of the article storage 20 and is capable of randomly selecting and supplying the articles P one by one, a lock portion 41 configured to lock the supply portion 21 so that the supply portion 21 cannot operate, and a control portion 40 configured to release the lock portion 41 when a coin C is inserted through an insertion slot 5.

In an unlocked state, an operating portion 4 on the front face portion 12 is rotationally operated. This operation rotates a shaft 4a and gears in a gear train 4b in the operating portion 4, rotating the rotation plate 22 by way of its rack gear 22g. The article P held in a holding hole 22h of the rotation plate 22 is rotationally conveyed, falls in a passage hole 20bh located in the bottom portion 20b, and is supplied to a supply port 9 via an article passage 9a.

The article storage 20 is attachable to and detachable from the front face portion 12 of the body portion 10, and articles P are added with the article storage 20 detached from the body portion 10.

The front face portion 12 of the article supply device 1 is provided with the operating portion 4 that enables operation for supplying the article P, the supply port 9 where the article P is dispensed, the insertion slot 5 through which a coin C is inserted, a return button 7, a coin return port 6, and other functions. The insertion slot 5, together with a coin insertion unit 8 located on the inner side of the insertion slot 5, functions as a payment validation portion that drives the control portion 40.

The back face portion 13 of the body portion 10 is provided with a holding portion 30 that can be held by the torso of the human body. This holding portion 30 includes, for example, a pair of right and left belt members: a first holding portion 31 and a second holding portion 32. The body portion 10 can be held on the back with the bottom face portion 14 lifted by placing the two holding portions 31 and 32 over both shoulders.

First end portions 30a of the first holding portion 31 and the second holding portion 32 on their upper sides are attached to a pair of upper-end attachment portions 34 at a specified distance apart in the right-left direction. Second end portions 30b on their lower sides are attached to lower-end attachment portions 35 located at lower end portions of the back face portion 13. The upper-end and lower-end attachment portions 34 and 35 on the back face portion 13 are located at positions close to an upper face portion 15 and positions close to the bottom face portion 14 in the back face portion 13. Specifically, the upper-end and lower-end attachment portions 34 and 35 are located at the corners of the back face portion 13. The first holding portion 31 and the second holding portion 32 are formed by using soft materials, for example, cloth as row material, and the body portion 10 and each of the holding portions 31 and 32 form a ring. Thus, the body portion 10 can be stably held on the back by holding it in the form of a backpack that utilizes the area of the back face portion 13 to the maximum by use of the holding portion 30 composed of the two parts.

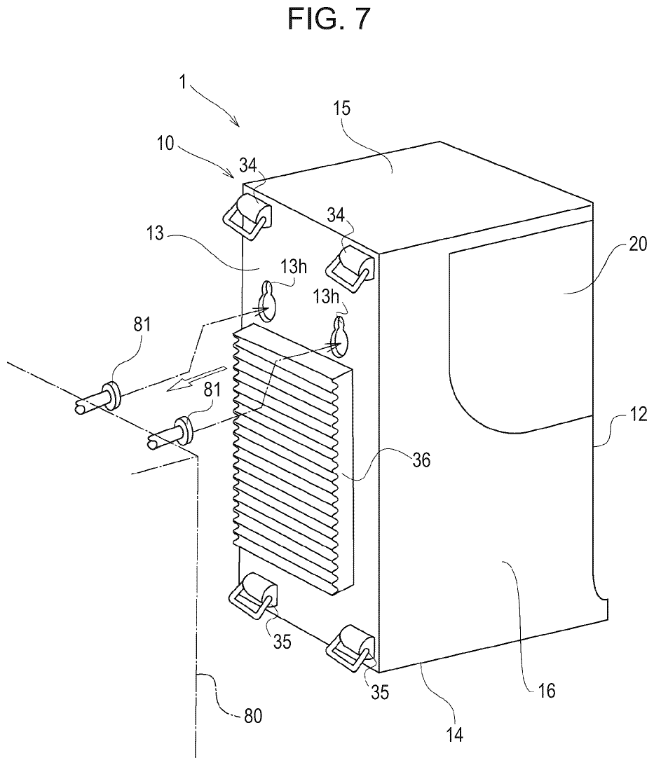

The back face portion 13 includes a cushioning member 36 having an appropriate thickness and covering approximately the entire part or a part of the back face portion 13. The present aspect is based on a configuration including one cushioning member 36 in a rectangular parallelepiped shape elongated in the vertical direction (see FIG. 7). The cushioning member 36 prevents the body portion 10, which is composed of a hard synthetic resin, from being in direct contact with the back. The cushioning member 36 is composed of a relatively thick elastic member. Hence, when the body portion 10 is held on the back, the cushioning member 36 can deform due to the weight of the body portion 10 such that its surface shape conforms to the shape of the back. The surface of the cushioning member 36 has an uneven surface 36a. This provides an anti-slip effect and a better feel for the back, and, additionally, the breathability and the like.

Each of the first holding portion 31 and the second holding portion 32 includes a length adjustment portion 33 with which the length of each holding portion in the attached state can be changed.

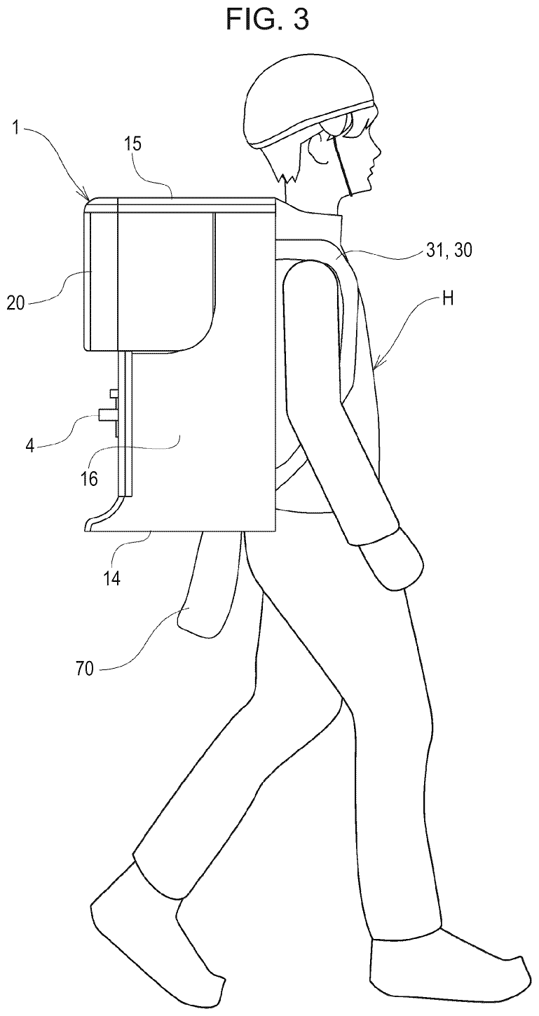

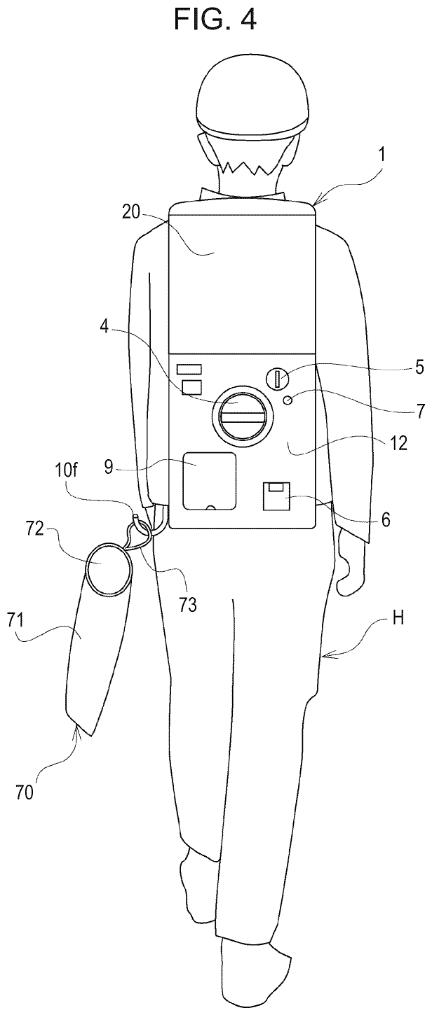

FIG. 3 is a side view of the article supply device 1 in a held state. FIG. 4 is a back view of the article supply device 1 in a held state.

As illustrated in FIGS. 3 and 4, the article supply device 1 is held on the back by using the holding portion 30, so that the article supply device 1 is not fixed at one place but can be moved anywhere. For example, a mobile article supply device 1 can be provided that can be held in a backpack form as in the illustration in event venues or the like. When a user in a venue wants to purchase an article P that can be supplied by the article supply device 1, the user gets the attention of the vendor H holding the article supply device 1 on the back, and ask him/her to stop. Then, the user approaches the article supply device 1 from the back of the vendor H, inserts a coin into the insertion slot 5, and operates the operating portion 4, and can take the article P out of the supply port 9.

After the user takes out the article P, the user, for example, opens the capsule case serving as a holding container and takes out the product inside. Then, if the user does not need the capsule case, it can be collected, for example, into a collecting portion 70. The collecting portion 70 includes, for example, a bag 71 having an opening 72 at its one end and provided with an attachment portion 73. The attachment portion 73 is attached to a hook 10f located on a side of the vendor H or the body portion 10, so that the collecting portion 70 can be close to the body portion 10.

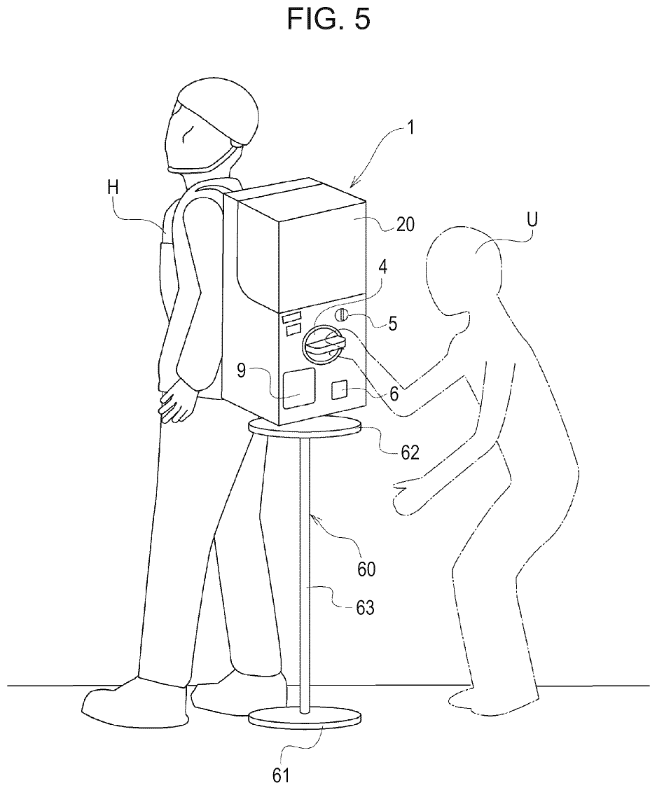

FIG. 5 is a perspective view of the article supply device 1, illustrating an example of an operable state.

In the state illustrated in FIG. 5, the bottom face portion 14 of the body portion 10 is supported by a table-shaped support device 60, and a user U is operating the article supply device 1. This support device 60 includes, for example, a lower-end flat surface portion 61 that is in contact with the floor surface, a flat placement portion 62 located at an upper portion, and one support shaft 63 connecting the two portions. The flat placement portion 62 has a size approximately equal to or slightly larger than the size of the bottom face portion 14 of the body portion 10. The lower-end flat surface portion 61 is composed of a relatively thin plate member not to make a step from the floor surface. The support device 60 configured as described above makes it easy for the vendor H holding the article supply device 1 on his/her back to place the bottom face portion 14 of the body portion 10 on the flat placement portion 62 with the article supply device 1 on his/her back, as illustrated in FIG. 5. In addition, this configuration makes operation easy when the user approaches as illustrated in FIG. 5. Since the bottom face portion 14 has a flat surface, the article supply device 1 can be stably placed on the flat placement portion 62.

The support device 60 may be placed at a plurality of locations in an event venue. However, for example, in the case in which the support device 60 is formed as a light member composed of aluminum, a vendor can carry it. The length of the support shaft 63 may be adjustable. In this case, the height of the support shaft 63 can be changed according to the height of the user U, so that the insertion slot 5, the operating portion 4, the supply port 9, and the like can be set to positions at which the user U can easily operate. In the state in which the body portion 10 is held on the back, the upper face portion 15 of the body portion 10 is lower than the back of the head of the vendor H holding the body portion 10. This configuration enables the vendor H to see the state of operation by the user U.

When articles P to be sold run out or are running low, the article supply device 1 is replenished with articles P. The replenishment of articles is performed with the article storage 20 detached from the body portion 10. However, for example, another worker can perform replenishment in the state in which the body portion 10 is held on the back of the vendor H. Hence, the workability is very high.

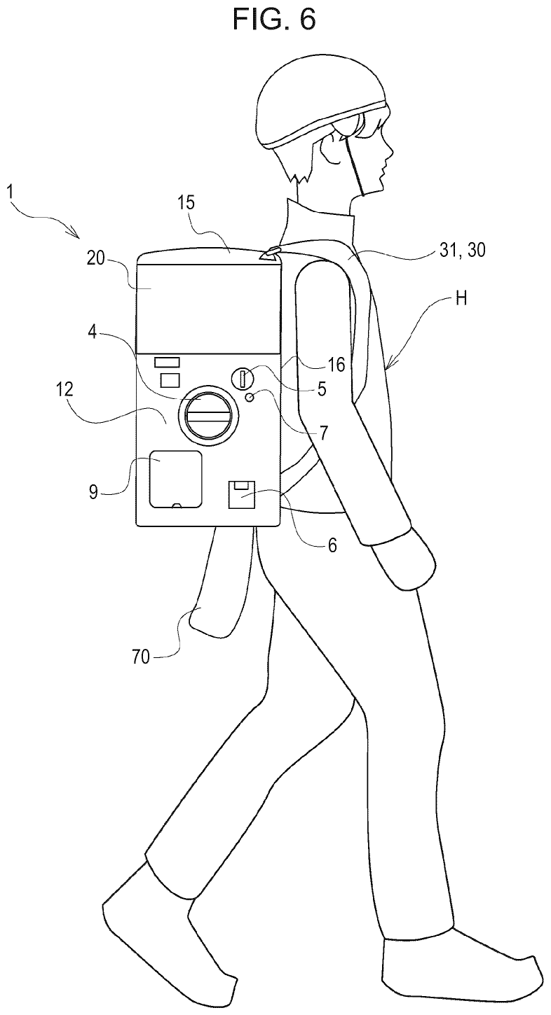

FIG. 6 is a side view showing another example of the way of holding the article supply device 1 on the back.

In the way of holding the article supply device 1 on the back illustrated in FIG. 6, the front face portion 12 of the device faces a side direction of the vendor H holding the device. In this case, the holding portion 30 is attached to, for example, the lower end of a side face portion 16 and the upper face portion 15. In this case, since the front face portion 12 faces in the side direction of the vendor H, the vendor H can easily communicate with the user U, and the vendor H can easily see and grasp the state of operation.

FIG. 7 is a perspective view showing another holding state of the article supply device 1.

In the article supply device 1 illustrated in FIG. 7, for example, the back face portion 13 includes a pair of right and left attachment holes 13h at upper positions on the back face portion 13. Then, a wall surface 80, where the article supply device 1 is attached, has protruding attachment pins 81 so as to correspond to the attachment holes 13h. For example, the attachment pins 81 are inserted into the attachment holes 13h and the body portion 10 is then shifted downward, so that the body portion 10 can be firmly fixed to the wall surface 80. Note that the back face portion 13 may be provided with the cushioning member 36, and the upper-end attachment portions 34 and the lower-end attachment portions 35 for the holding portion 30. The article supply device 1 including the body portion 10 thus configured can be used in both a wall attachment configuration and a backpack configuration. In the configuration example illustrated in FIG. 7, a belt may be provided connecting the two upper-end attachment portions 34 located at the upper end of the back face portion 13, and this belt may be hung on a nail or the like fixed to the wall surface 80 to achieve a wall attachment configuration.

Since the body portion 10 of the article supply device 1 of the present aspect can be held with the bottom face portion 14 lifted as described above, the attachment place is not limited, and the article supply device 1 is highly versatile. When a tall person purchases a product, he/she can do it in a comfortable posture.

In the article supply device 1 of the present aspect, since the body portion 10 is provided with the holding portion 30 that enables the body portion 10 to be held with the back face portion 13 facing the front, the back, or a side of the torso of the human body, it is possible to carry the article supply device 1.

In the article supply device 1 of the present aspect, since the back face portion 13 is provided with the cushioning member 36, the contact with the human body is soft, making it easy to carry the article supply device 1.

Since the cushioning member 36 has the uneven surface 36a, the contact with the human body can be favorable, making it easy to hold the article supply device 1.

Since the article supply device 1 of the present aspect includes the belt-shaped holding portion 30 that enables the back face portion 13 or the side face portion 16 to be in contact with the human body, and for example, the body portion 10 can be held on the back, a person can keep firmly holding the article supply device 1. This makes it possible to insert a coin and operate the operating portion 4 and to take a product out of the supply port 9 in the state in which the article supply device 1 is held by a person.

In the article supply device 1 of the present aspect, since the holding portion 30 has a backpack configuration in which the right and left belt portions composed of a flexible soft material are located at a specified distance apart, the body portion 10 can be firmly held on the back. In addition, since the lengths of the right and left belt portions are adjustable and can be adapted to the body shape of the holding person, more secure holding is possible.

In the article supply device 1 of the present aspect, since the body portion 10 is held to be lower than the head of the holding person in the state in which the article supply device 1 is held on the back, it is possible to visually grasp the state of operation when the user U is operating.

In the article supply device 1 of the present aspect, since the article storage 20 is attachable to and detachable from the front face portion 12, articles P can be added with the article supply device 1 held on the back of a person.

In the article supply device 1 of the present aspect, in the case in which the bottom face portion 14 of the body portion 10 has a flat surface, the article supply device 1 can be stably placed on an approximately level placement portion. In addition, in the case in which the back face portion 13 has a flat surface and is provided with an attachment structure, the article supply device 1 can be attached and held, for example, on a wall surface or the like.

In the article supply device 1 of the present aspect, since the collecting portion 70 can be held at a position close to the body portion 10, a container such as a capsule case for the article P can be smoothly collected, improving usability for the user U.

Although an aspect of the present invention has been described above, the present invention can be changed as appropriate within the scope of the technical ideas. For example, although the above-mentioned aspect is based on a configuration in which the back face portion 13 is held on the back of the torso of the human body, the present invention is not limited to this configuration. A configuration in which the back face portion 13 is held on the front of the human body is possible. Alternatively, a shoulder configuration in which the back face portion 13 is held on a side of the human body is also possible.

Although the above-mentioned aspect is based on a configuration in which the upper-end attachment portions 34 and the lower-end attachment portions 35 for the holding portion 30 are located on the back face portion 13, the locations are not limited to the back face portion 13. For example, the upper-end attachment portions 34 and the lower-end attachment portions 35 may be located on the bottom face portion 14, the upper face portion 15, or the side face portion 16.

Although the support device 60 in the above-mentioned aspect is in the form of a table, the present invention is not limited to this configuration. For example, the support device may be composed of two rod-shaped members, similar to walking sticks, that the vendor holding the article supply device 1 on the back holds by his/her hands. For example, the two rod-shaped members may be engaged with the bottom face portion 14 of the body portion 10 to support the body portion 10.

Although the article supply device 1 of the above-mentioned aspect is for articles P having spherical capsule cases, the present invention is not limited to this configuration. For example, the article supply device 1 may be for supplying flat articles.

As described above, the present specification discloses the following items.

(1)

An article supply device including:
a body portion including a front face portion, a back face portion, and a bottom face portion;
an operating portion that is located on the front face portion and enables operation for supplying an article; and
a supply port that is located on the front face portion and through which the article in the device can be supplied, in which
the body portion can be held with the bottom face portion lifted.
   (2)

The article supply device according to (1), in which
the body portion is provided with a holding portion that enables the body portion to be held with the back face portion facing a front, a back, or a side of a torso of a human body.
   (3)

The article supply device according to (2), in which
the back face portion includes a cushioning member.
   (4)

The article supply device according to (3), in which
the cushioning member has an uneven surface.
   (5)

The article supply device according to any one of (2) to (4), in which
a first end portion and a second end portion of the holding portion are attached at different positions on the back face portion.
   (6)

The article supply device according to (5), in which
the body portion includes an upper face portion,
the first end portion of the holding portion is attached to the upper face portion or a vicinity of the upper face portion, and
the second end portion of the holding portion is attached to the bottom face portion or a vicinity of the bottom face portion.
   (7)

The article supply device according to (4) or (5), in which
the body portion includes a side face portion, and
the first end portion and the second end portion of the holding portion are attached at different positions on the side face portion.
   (8)

The article supply device according to any one of (2) to (7), in which
the holding portion includes a first holding portion and a second holding portion, and
the first holding portion and the second holding portion are located at a certain distance apart.
   (9)

The article supply device according to (8), in which
a length of a long side of the first holding portion and a length of a long side of the second holding portion are adjustable.
   (10)

The article supply device according to (8) or (9), in which
each of the first holding portion and the second holding portion, together with the back face portion, forms a ring, and
a length of the ring is adjustable.
   (11)

The article supply device according to any one of (8) to (10), in which
the body portion is composed of a hard material, and
the first holding portion and the second holding portion are composed of a soft material.
   (12)

The article supply device according to (11), in which
the soft material is fabric.
   (13)

The article supply device according to any one of (2) to (12), in which
the body portion is configured such that in a state in which the body portion is held, the upper face portion is lower than back of a head of a human body holding the body portion.
   (14)

The article supply device according to any one of (2) to (13), in which
the body portion and the holding portion form a backpack configuration.
   (15)

The article supply device according to any one of (1) to (14), in which
the body portion is configured such that a position of the supply port can be changed in a state in which the body portion is held.
   (16)

The article supply device according to any one of (1) to (15), in which
the operating portion is operable in a state in which the body portion is held.
   (17)

The article supply device according to any one of (1) to (16), in which
the body portion includes an attachable and detachable article storage, and
the article storage allows a position of the article contained to be changed in a state in which the body portion is held.
   (18)

The article supply device according to (17), in which
the article storage is attachable and detachable in a state in which the body portion is held.
   (19)

The article supply device according to any one of (1) to (18), in which
the body portion includes a payment validation portion on the front face portion, and
the payment validation portion is capable of validating payment in a state in which the body portion is held.
   (20)

The article supply device according to any one of (1) to (19), in which
the article supplied is allowed to be taken out of the supply port in a state in which the body portion is held.
   (21)

The article supply device according to any one of (1) to (20), in which
at least the bottom face portion of the body portion has a flat surface.
   (22)

An article supply device set including:
the article supply device according to any one of (1) to (21); and
a support device capable of supporting the article supply device, in which
the support device is configured to be in contact with an outer surface of the body portion when supporting the article supply device.
   (23)

An article supply device set including:
the article supply device according to any one of (1) to (21); and
a collecting portion into which a container of the article supplied from the article supply device can be collected, in which
the collecting portion is configured to be held at a position close to the body portion such that a container of the article supplied can be collected into the collecting portion.

What is claimed is:

1. An article supply device comprising:
a body portion including a front face portion, a back face portion, and a bottom face portion;
an operating portion that is located on the front face portion and enables operation for supplying an article; and
a supply port that is located on the front face portion and through which the article in the device can be supplied, wherein
the body portion can be held with the bottom face portion lifted.

2. The article supply device according to claim 1, wherein
the body portion is provided with a holding portion that enables the body portion to be held with the back face portion facing a front, a back, or a side of a torso of a human body.

3. The article supply device according to claim 2, wherein
the back face portion includes a cushioning member.

4. The article supply device according to claim 3, wherein
the cushioning member has an uneven surface.

5. The article supply device according to claim 4, wherein
a first end portion and a second end portion of the holding portion are attached at different positions on the back face portion.

6. The article supply device according to claim 5, wherein
the body portion includes an upper face portion,
the first end portion of the holding portion is attached to the upper face portion or a vicinity of the upper face portion, and
the second end portion of the holding portion is attached to the bottom face portion or a vicinity of the bottom face portion.

7. The article supply device according to claim 5, wherein
the body portion includes a side face portion, and
the first end portion and the second end portion of the holding portion are attached at different positions on the side face portion.

8. The article supply device according to claim 2, wherein
the holding portion includes a first holding portion and a second holding portion, and
the first holding portion and the second holding portion are located at a certain distance apart.

9. The article supply device according to claim 8, wherein
a length of a long side of the first holding portion and a length of a long side of the second holding portion are adjustable.

10. The article supply device according to claim 9, wherein
each of the first holding portion and the second holding portion, together with the back face portion, forms a ring, and
a length of the ring is adjustable.

11. The article supply device according to claim 10, wherein
the body portion is composed of a hard material, and
the first holding portion and the second holding portion are composed of a soft material.

12. The article supply device according to claim 11, wherein
the soft material is fabric.

13. The article supply device according to claim 12, wherein
the body portion is configured such that in a state in which the body portion is held, the upper face portion is lower than back of a head of a human body holding the body portion.

14. The article supply device according to claim 13, wherein
the body portion and the holding portion form a backpack configuration.

15. The article supply device according to claim 14, wherein
the operating portion is operable in a state in which the body portion is held.

16. The article supply device according to claim 15, wherein
the body portion is configured such that a position of the supply port can be changed in a state in which the body portion is held.

17. The article supply device according to claim 16, wherein
the body portion includes an attachable and detachable article storage, and
the article storage allows a position of the article contained to be changed in a state in which the body portion is held.

18. The article supply device according to claim 17, wherein
the article storage is attachable and detachable in a state in which the body portion is held.

19. The article supply device according to claim 18, wherein
the body portion includes a payment validation portion on the front face portion, and
the payment validation portion is capable of validating payment in a state in which the body portion is held.

20. The article supply device according to claim 19, wherein
the article supplied is allowed to be taken out of the supply port in a state in which the body portion is held.

21. The article supply device according to claim 20, wherein
at least the bottom face portion of the body portion has a flat surface.

22. An article supply device set comprising:
the article supply device according to claim 1; and
a support device capable of supporting the article supply device, wherein
the support device is configured to be in contact with an outer surface of the body portion when supporting the article supply device.

23. An article supply device set comprising:
the article supply device according to claim 1; and
a collecting portion into which a container of the article supplied from the article supply device can be collected, wherein
the collecting portion is configured to be held at a position close to the body portion such that a container of the article supplied can be collected into the collecting portion.
